(19) United States
(12) Patent Application Publication
(10) Pub. No.: US 2015/0047349 A1
(43) Pub. Date: Feb. 19, 2015

(54) TURBOCHARGER WITH ALUMINUM BEARING HOUSING

(71) Applicant: BorgWarner Inc., Auburn Hills, MI (US)

(72) Inventors: John Palko, Arden, NC (US); John Norton, Candler, NC (US)

(21) Appl. No.: 14/395,223

(22) PCT Filed: Apr. 9, 2013
(86) PCT No.: PCT/US2013/035732

§ 371 Date: Oct. 17, 2014

Related U.S. Application Data
(60) Provisional application No. 61/636,778, filed on Apr. 23, 2012.

(51) Int. Cl. F04D 29/056; F02B 39/14; F04D 29/063; F02B 37/00

(52) U.S. Cl. CPC F04D 29/056; F02B 37/00; F02B 39/14; F04D 29/063
USPC 60/605.3; 415/229

(57) ABSTRACT

In an aluminum turbocharger bearing housing, there is a potential for wear of the bearing housing at the interface with the journal bearing system. With a protective hard anodized surface, the wear resistance and resistance to chemical attack of the bearing housing can be improved so that an aluminum bearing housing can have the life of a cast iron bearing housing, at greatly reduced weight.

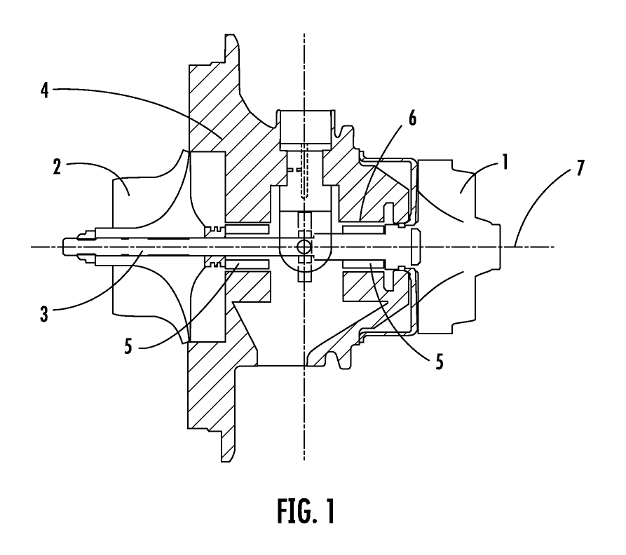

### FIELD OF THE INVENTION

The invention relates in general to turbochargers with an aluminum bearing housing, and, more particularly, to aluminum bearing housings with bearing surfaces chemically modified for wear resistance.

### BACKGROUND OF THE INVENTION

Turbochargers are a type of forced induction system. They deliver air, at greater density than would be possible in the normally aspirated configuration, to the engine intake, allowing more fuel to be combusted, thus boosting the engine's horsepower without significantly increasing engine weight.

The rotating assembly, including turbine wheel, shaft and compressor wheel, rotates at speeds up to 300,000 RPM. Turbocharger life should correspond to that of the engine, which could be 1,000,000 km for a commercial vehicle. To achieve this long life, hydrodynamic journal bearings are used to support the rotating assembly within the bearing housing. A hollow cylindrical hydrodynamic or “floating” journal bearing is inserted between the shaft and the bearing bore in the bearing housing, with bearing clearances of only a few hundredths of a millimeter. As the shaft turns on an oil film inside the journal bearing, the shear tension in the oil drags the floating journal bearing to follow the rotational motion of the shaft. It is normal to see the bearing rotating at approximately 33% of shaft speed in the static bearing housing.

In modern automotive applications, the mass of the vehicle has a direct influence on vehicle efficiency, thus is a major issue. In an effort to reduce the mass of a turbocharger, an aluminum bearing housing is being substituted for the former traditional gray iron bearing housing. This change in material produces a mass reduction in the range of 55% to 65% for the bearing housing. However, aluminum is relatively soft compared to gray iron. The bore in the aluminum bearing housing in which the journal bearing rotates may not be able to withstand exposure to loads from the journal bearing over the turbocharger life expectancy.

That is, the shaft does not rotate about a precise axis; rather, it describes a series of orbits (see US Patent Application Publication US 2010/0008767 A1). Hydrodynamic bearings allow the shaft to rotate under control. As the shaft speed increases, the end of the shaft at the compressor-end describes small loops and these loops themselves describe a larger orbital trace. The rotor dynamics of a turbocharger are quite complex. Dynamic loads on the rotating assembly can come from rotating assembly unbalance or rotating assembly modal excursions; from engine events such as engine vibrations, exhaust manifold vibration, combustion events, etc.; as well as from vehicle events (e.g., traveling on a rough road). An aluminum bore can not be expected to withstand repeated exposure to these forces over the life of the turbocharger.

It is known to insert a steel sleeve into the bearing bore of a bearing housing to provide a bearing surface with improved wear resistance. However, compression fitting a sleeve may cause the sleeve internal surface to deviate from perfect roundness, which could have adverse effects on bearing stability and rotating shaft efficiency. While such deformations can be redressed by post-press machining or grinding of the sleeve to restore cylindricity, it would be desirable to avoid the need to (a) detect and (b) correct imperfections. Further, contact between dissimilar metals accelerates corrosion of steel.

Thus, there is a need for systems and methods that can permit the use of an aluminum bearing housing in a turbocharger while providing a suitable interface with the journal bearings.

### SUMMARY OF THE INVENTION

Embodiments described herein facilitate the use of an aluminum bearing housing by providing a system and method for protecting the interface between the bearing housing and the floating journal bearing, thereby avoiding wear and other issues that may arise from the use of an aluminum bearing housing, while allowing the advantages associated with the use of such a light-weight bearing housing to be realized.

### BRIEF DESCRIPTION OF THE DRAWING

The present invention is illustrated by way of example and not limitation in the accompanying drawing showing a cross-sectional view of a typical turbocharger bearing housing and rotating assembly with a hydrodynamic journal bearing.

### DETAILED DESCRIPTION OF THE INVENTION

The rotating assembly, including turbine wheel (1), shaft (3) and compressor wheel (2), is rotatingly supported within the bearing housing (4) via a pair of hollow cylindrical hydrodynamic or “floating” journal bearings (5) inserted between the shaft and the bearing bore in the bearing housing, with bearing clearances of only a few hundredths of a millimeter.

Turbochargers use the exhaust flow from the engine exhaust manifold to drive the turbine wheel (1). The energy extracted by turbine wheel (1) is translated to a rotating motion, which is transmitted via the shaft (3) to drive the compressor wheel (2), which is located within a compressor cover (not shown). The compressor wheel draws air into the compressor housing, compresses this air, and delivers it to the intake side of the engine.

The shaft (3) is rotatingly supported on the hydrodynamic bearing, which is fed oil, typically supplied by an engine oil pump. The “floating” journal bearings (5) are free to rotate within the bearing housing, and the shaft freely rotates within the journal bearing. Typically, the journal bearing bore (6) is finished to a very high degree of cylindricity and surface finish. The action of the shaft rotation about shaft axis (7) relative to the journal bearing (5) inner surface generates a multi-lobed oil wedge, which supports the shaft inside the journal bearing. The shear tension in the oil drags the journal bearing to follow the rotational motion of the shaft. The rotational speed of the bearing is approximately one third the speed of the shaft. As with the dynamics between shaft and inner bearing, the relative motion of the outer diameter of the bearing, which is rotating, and the inner diameter of the bearing housing bore, which is static, produces a like multi-lobed oil wedge which then supports the journal bearing inside the bearing housing.

Most turbochargers mount to an engine via the turbine housing foot. In these cases, road vibration and engine vibration are transmitted through the foot to the bearing housing and rotating assembly, so the interface between journal bearing and bearing housing is susceptible to wear.

In accordance with the present invention, the toughness and abrasion resistance of the bearing bore (6) in the bearing housing (4) is improved in that the bearing bore surface is hard anodized. Simple anodization of aluminum deposits a coating of aluminum oxide, using a strongly acidic bath. A drawback of this method is the nature of the anodized coating produced. The aluminum oxide coating is not very impervious to acid and alkali. “Hard anodizing” is an extension of the process using higher voltage and lower temperature, which results in an even harder and more durable coating. So called hard anodizing aluminum results in a harder coating of aluminum oxide, deposited by anodic coating at pH<1 and temperatures of less than 3° C., which generates an alpha phase alumina crystalline structure. Hard anodizing of aluminum and of aluminum alloys enables a porous, refractory oxide film of Al₂O₃ to be produced that has the hardness of sapphire and is resistant to abrasion and to chemical attack. The wearing qualities of hard anodized aluminum and aluminum alloys can be equal to or superior to case hardened steel so that aluminum parts can be used in applications where only hardened steel was formerly employed. For brevity, the term “aluminum” as hereinafter used in this exposition includes the alloys of that metal unless the text indicates otherwise.

Sulfuric acid is the most widely used solution to produce anodized coating. Coatings of moderate thickness 1.8 μm to 25 μm (0.00007″ to 0.001″) are known as Type II in North America, as named by MIL-A-8625, while coatings thicker than 25 μm (0.001″) are known as Type III, hardcoat, hard anodizing, or engineered anodizing. Thick coatings require more process control, and are produced in a refrigerated tank near the freezing point of water with higher voltages than the thinner coatings. Hard anodizing can be made between 13 and 150 μm (0.0005″ to 0.006″) thick. Anodizing thickness increases wear resistance, corrosion resistance, ability to retain lubricants and PTFE coatings, and electrical and thermal insulation. Standards for thick sulfuric anodizing are given by MIL-A-8625 Type III, AMS 2469, BS 5599, BS EN 2536 and the obsolete AMS 2468 and DEF STAN 03-26/1.

Hard anodizing can be accomplished for example in accordance with the teachings of U.S. Pat. No. 4,128,461 (Lerner et al) entitled “Aluminum Hard Anodizing Process”. Hard coating of aluminum is produced by the electrochemical oxidation of aluminum in a strong electrolyte containing acids such as sulfuric acid, phosphoric acid, oxalic acid, or chromic acid. The concentration of electrolyte, the temperature of the bath, and the electric current density are adjusted to cause the rate of formation of the oxide film to be greater than the rate at which the oxide film dissolves. In accordance with the teachings of this patent, a high quality, hard oxide film can be produced on aluminum with an electrolyte in which (1) the concentration of sulphuric acid is usually within the range from 5.7% by volume or 100 grams per liter to 23% by volume or 400 grams per liter, (2) the temperature of the electrolyte is around 0° C. (3) the DC voltage at the start of anodizing is between 15 to 18 volts and is between 40 to 90 volts at the end of the process and (4) the anodizing time is about an hour. The type of alloy and the thickness of the oxide film that is to be produced determine the conditions of temperature, voltage, electrolyte concentration and time in the anodizing process.

Another method of forming a protective coating on a surface of a metal article comprising aluminum or aluminum alloy comprises:

A) providing an anodizing solution comprised of water and one or more additional components selected from the group consisting of: a) water-soluble complex fluorides, b) water-soluble complex oxyfluorides, c) water-dispersible complex fluorides, and d) water-dispersible complex oxyfluorides of elements selected from the group consisting of Ti, Zr, Hf, Sn, Al, Ge and B and mixtures thereof;

B) providing a cathode in contact with said anodizing solution;

C) placing a metal article comprising aluminum or aluminum alloy as an anode in said anodizing solution;

D) passing a pulsed direct current between the anode and cathode through said anodizing solution for a time effective to form a first protective coating on the surface of the metal article; and

E) removing the metal article having a first protective coating from the anodizing solution and drying said article.

A titanium oxide or zirconium oxide coating provides better wear resistance than mere aluminum oxide.

In terms of Vickers pyramid number (VPN), also referred to as the Vickers hardness number (HV or VHN), untreated aluminum alloy 6082 has a HV 100-120. Hard anodized alloy 6082 has a HV 400-460. Stainless steel has a HV 300-350 and mild steel has a HV 200-220.

In accordance with the present invention, it is necessary that the bearing bore (6) of the bearing housing (4) is treated to provide a wear-resistant, hard anodized surface. This can be accomplished by masking parts of the bearing housing not to be treated, and immersing the bearing housing in an anodizing bath. It is however within the contemplation of the inventors that other areas of the bearing housing could benefit from the hard anodizing treatment. Thus, other bearing surfaces, such as the faces of the bearing housing in contact with turbine housing or compressor housing, or the pedestal, could be hard anodized.

Further, hard anodized areas can be painted or coated with materials to provide an attractive appearance.

Arrangements described herein relate to device turbocharger with an aluminum bearing housing configured for improved interface with the turbine housing and/or bearing system. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure.

By providing the aluminum bearing housing with a wear resistant journal bearing bore, it becomes possible to extend the life of the bearing bore such that an aluminum bearing housing can be used in a turbocharger, thereby allowing for mass reduction and the associated reduction in the moment carried on the turbine housing to bearing housing interface.

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible within the scope of the following claims.

1. A turbocharger comprising:
an aluminum bearing housing (4) having at least one bearing bore (6) adapted for receiving a journal bearing (5);
a rotating assembly including compressor wheel (2), turbine wheel (1), and shaft (3) connecting the compressor wheel and turbine wheel, wherein the shaft extends through the bearing bore;
a journal bearing (5) provided between the shaft an the bearing bore;
wherein at least the surface of the bearing bore (6) is hard anodized.

2. The turbocharger as in claim 1, wherein the hard anodized surface further includes at least one oxide selected from titanium, zirconium, hathium, tin, germanium and boron.

3. The turbocharger as in claim 1, wherein the hard anodized surface includes titanium oxide.

4. The turbocharger as in claim 1, wherein the hard anodized surface includes zirconium oxide.

5. The turbocharger as in claim 1, wherein the hard anodized surface has a hardness of HV 400-460.

6. The turbocharger as in claim 1, wherein the hard anodized surface is obtained by a Type III anodization.

7. The turbocharger as in claim 6, wherein the hard anodized surface forms a coating greater than 25 μm in thickness.

8. The turbocharger as in claim 1, wherein the hard anodized surface is obtained by a Type II anodization.

9. The turbocharger as in claim 6, wherein the anodized surface forms a coating with a thickness of 1.8 μm to 25 μm.
